(19) United States
(12) Patent Application Publication
(10) Pub. No.: US 2015/0030356 A1
(43) Pub. Date: Jan. 29, 2015

(54) CHARGE BLADE HAVING MULTIPLE CONTACT POINT METERING

(71) Applicant: XEROX CORPORATION, NORWALK, CT (US)

(72) Inventor: Michael F. Zona, Holley, NY (US)

(73) Assignee: XEROX CORPORATION, NORWALK, CT (US)

(21) Appl. No.: 13/948,242

(22) Filed: Jul. 23, 2013

(51) Int. Cl. G03G 15/08

(52) U.S. Cl. CPC G03G 15/0812
USPC 399/284

(57) ABSTRACT

A charge blade meters and applies an electrical charge to toner while the toner is on a development roll. The end portion of the charge blade comprises a first curved surface and a second curved surface touching the development roll. The first curved surface has a smaller radius and is a longer distance from the middle portion of the charge blade relative to the second curved surface. The first curved surface produces a first amount of charge in the toner on the development roll, and the second curved surface increases and makes more uniform the charge within the toner on the development roll. Also, the smaller radius of the first curved surface controls the amount of toner positioned on the development roll and the larger radius of the second curved surface does not affect the amount of toner metered by the first, smaller radius curved surface.

### BACKGROUND

Systems and methods herein generally relate to printing devices and more particularly to charge blades within electrostatic printing devices.

Electrostatic printing devices deliver a controlled amount of charged marking material (e.g., toner) to a photoreceptor (or other element capable of maintaining a latent image charge) using what is sometimes referred to as a development roll. The marking material is transferred from the development roll to the photoreceptor, and then from the photoreceptor to a sheet of media to perform printing on the sheet.

The marking material is usually in the form of a powder, such as toner particles. In order to control (or “meter”) the amount of marking material that exists on the development roll, a blade is used to scrape excess amounts of marking material off the development roll. In addition, the blade can provide a charge to the marking material particles and, therefore, the blade is sometimes referred to as a “charge blade.”

### SUMMARY

An exemplary printing apparatus herein includes a sheet feeder and a photoreceptor adjacent the sheet feeder. The photoreceptor receives print media from the sheet feeder, and the photoreceptor transfers toner to the print media. A development roll is adjacent the photoreceptor. The development roll supplies a metered amount of charged toner to the photoreceptor. Also, a supply roll is adjacent the development roll. The supply roll supplies toner to the development roll. In this device, a charge blade contacts the development roll, and a charge generator is electrically connected to the charge blade, supply roll, and development roll.

The charge blade has a middle portion and an end portion. The end portion of the charge blade touches the development roll. The charge blade applies a force against the development roll to enable friction between the toner and the development roll, which electrically charges the toner. The end portion of the charge blade comprises a first curved surface and a second curved surface touching the development roll. The second curved surface is positioned, on the charge blade, between the first curved surface and the middle portion of the charge blade. Thus, the first curved surface is a longer distance from the middle portion of the charge blade relative to the second curved surface. The first curved surface also has a smaller radius relative to a larger radius of the second curved surface.

The development roll has an outer surface moving in a first direction. The first curved surface of the end portion of the charge blade is positioned before the second curved surface in the first direction. Therefore, the moving outer surface of the development roll contacts the first curved surface before contacting the second curved surface (when moving in the first direction). Also, the first curved surface of the end portion of the charge blade comprises a first contact area touching the surface of the development roll and, similarly, the second curved surface of the end portion of the charge blade comprises a second contact area touching the surface of the development roll. The first contact area and the second contact area are parallel linear areas running in a second direction perpendicular to the first direction (from side to side, across the surface of the development roll).

Additionally, the outer surface of the development roll is a curved surface. There may be additional “second” curved surfaces between the second curved surface and the middle portion of the charge blade. The contact areas of all such curved surfaces are positioned in an arc, such that all of the contact areas of the curved surfaces simultaneously touch the curved outer surface of the development roll.

The first curved surface produces a first amount of charge in the toner on the development roll, and the second curved surface increases the charge within the toner on the development roll (e.g., to a second amount of charge that is larger than the first amount of charge). Also, the smaller radius of the first curved surface controls the amount of toner positioned on the development roll and the larger radius of the second curved surface does not affect the amount of toner metered by the first, smaller radius curved surface.

Stated in more generic terms, various print devices herein include a media feeder (one example of which is a sheet feeder); and a transfer device (one example of which is a photoreceptor) adjacent the media feeder. The transfer device receives print media from the media feeder, and the transfer device transfers marking material (one example of which is a toner) to the print media. A marking material feeder (one example of which is a development roll) is adjacent the transfer device. The marking material feeder supplies the marking material to the transfer device. Further, a supply device (one example of which is a supply roll) is adjacent the marking material feeder. The supply device supplies the marking material to the marking material feeder.

A charge blade contacts the marking material feeder, and a charge generator is electrically connected to the charge blade, supply roll, and development roll. The charge blade has a middle portion and an end portion. The end portion of the charge blade touches the marking material feeder, and the end portion of the charge blade applies a force against the development roll to enable friction between the toner and the development roll, which electrically charges the toner.

Again, the end portion of the charge blade comprises a first curved surface (e.g., a consistent/uniform arc shape) touching the marking material feeder and a second curved surface (e.g., also a consistent/uniform arc shape, but different from the first curved surface) touching the marking material feeder. The second curved surface is positioned, on the charge blade, between the first curved surface and the middle portion of the charge blade. Thus, the first curved surface is located/positioned a longer distance from (is further away from) the middle portion of the charge blade relative to the second curved surface. While both have arc shapes, the first curved surface has a smaller radius relative to a larger radius of the second curved surface.

The marking material feeder has an outer surface moving (e.g., rotating) in a first direction. The first curved surface is positioned before the second curved surface in the first direction (the second curved surface is positioned between the first curved surface and the middle portion of the charge blade) such that the rotating outer surface of the marking material feeder contacts the first curved surface before contacting the second curved surface (when moving in the first direction). Also, the first curved surface has a first contact area touching the curved outer surface of the material feeder, and the second curved surface similarly has a second contact area touching the curved outer surface of the material feeder. The first contact area and the second contact area form parallel linear areas running in a second direction perpendicular to the first direction (running from one edge of the outer surface of the marking material feeder to the opposite edge across the outer surface of the marking material feeder).

Additional curved surfaces can be positioned between the second curved surface and the middle portion of the charge blade. The first curved surface and the additional curved surfaces comprise contact areas touching the curved outer surface of the marking material feeder. The contact areas of the first curved surface and the additional curved surfaces are positioned in an arc, and all of the contact areas simultaneously touch the curved outer surface of the marking material feeder.

The first curved surface produces a first amount of charge in the marking material on the marking material feeder, and the second curved surface increases the charge within the marking material on the marking material feeder (to a second amount of charge that is larger than the first amount of charge). Also, the smaller radius of the first curved surface controls (meters) the amount of marking material positioned on the marking material feeder, and the larger radius of the second curved surface does not affect the amount of marking material metered on the marking material feeder by the first curved surface.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a cross-sectional schematic diagram illustrating devices herein;

FIG. 2 is a cross-sectional schematic diagram illustrating devices herein;

FIG. 3 is a cross-sectional schematic diagram illustrating devices herein;

FIG. 4 is a perspective-view schematic diagram illustrating devices herein; and

FIG. 5 is a cross-sectional schematic diagram illustrating devices herein.

### DETAILED DESCRIPTION

As mentioned above, a charge blade is used to remove excess amounts of marking material from the development roll and provide a charge to the marking material particles, thereby “metering charged particles” on the development roll. The devices described herein include multiple rounded (curved) contact points having different radii at the end portion of the charge blade to provide precise metering and charge control of marking material particles on a development roll.

The physical structures described herein allow many different types of marking materials to be used in printing devices that require highly controlled charge and metering levels (and would otherwise require specialized marking materials). Therefore, in one example, the physical structures described herein allow a wider variety of marking materials to be used in devices that require a specific type of marking material, allowing less-polluting, lower-cost marking materials to be used in place of more expensive, more rare marking materials. This promotes more recycling of printing cartridges by a wider range of manufacturers, increasing competition, reducing consumer prices, and helping the environment.

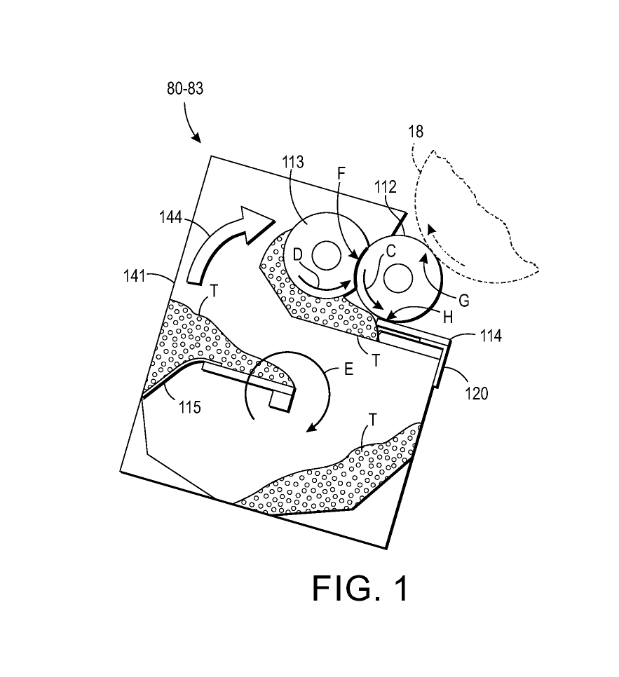

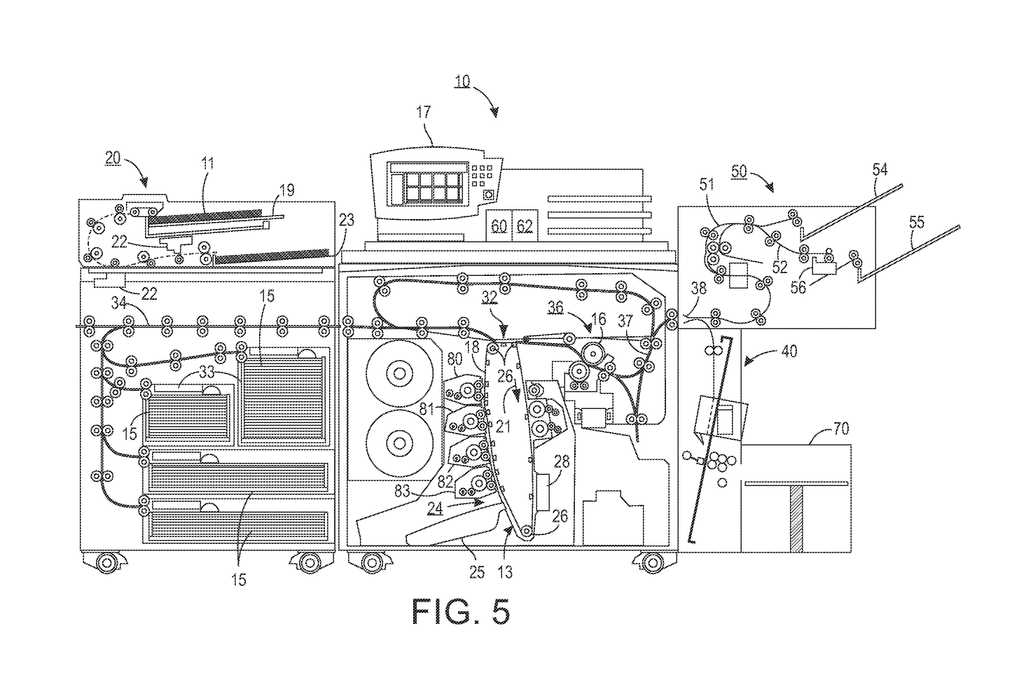

FIG. 1 illustrates a cross-section of a development system 80-83. In some examples herein a printing device can include a single development system, and others (such as the one illustrated in FIG. 5, discussed below) can include multiple development systems 80-83. Therefore, FIG. 1 is intended to illustrate a stand-alone development device and/or a development device used in combination with other development devices.

As shown in FIG. 1, toner (T) is maintained in the cartridge sump 141. A paddle 115 that rotates as shown by arrow E, is used to load a supply roller 113 with toner T by moving toner particles to the supply roll area in a direction shown by arrow 144. As shown by arrow D, the supply roller 113 rotates to transfer the toner T to a development roll 112 in a nip F created between the two rolls. In some embodiments, the orientation of the development system 80-83 may be upside down relative to that shown in FIG. 1, so that gravity is used to move toner particles to the supply roll area, instead of a paddle 115.

A charge generator 120 can transfer charge to a charge blade 114 and the charge blade 114 can apply a force against the development roll 112 to generate friction between the toner T and the development roll 112, which electrically charges the toner. The charge blade scrapes off excess toner T from the development roll 112 to meter (control) the amount of toner T that remains on the development roll 112 as the surface of the development roll 112 moves toward a photoreceptor 18. Thus, as the development roll 112 rotates as shown by arrow C, the toner T is charged and metered in the nip H of the charge blade 114 that is held in contact against the development roll 112 with a pre-determined force. After the surface of the development roll 112 moves past the charge blade 114, enough charged toner T is brought into the development zone G (at the nip G where the development roll contacts the photoreceptor 18) to support acceptable solid area and halftone uniformity on the latent image on the photoreceptor 18.

The charge blade 114 can be made of any electrically conductive material, such as a thin piece of metal (e.g., steel, bronze, copper, etc.), plastic, polymer, alloy, etc., that is mounted on a rigid holder connected to the development housing. The physical properties and the dimensions of the charge blade 114 (i.e. modulus, thickness, free length, etc.) are selected to provide an optimal normal force against the development roll 112 that will provide good charging and metering of the toner that enters into the nip H. As shown by the force arrow in the drawings, the blade force is perpendicular to the developer roll 112 circumference.

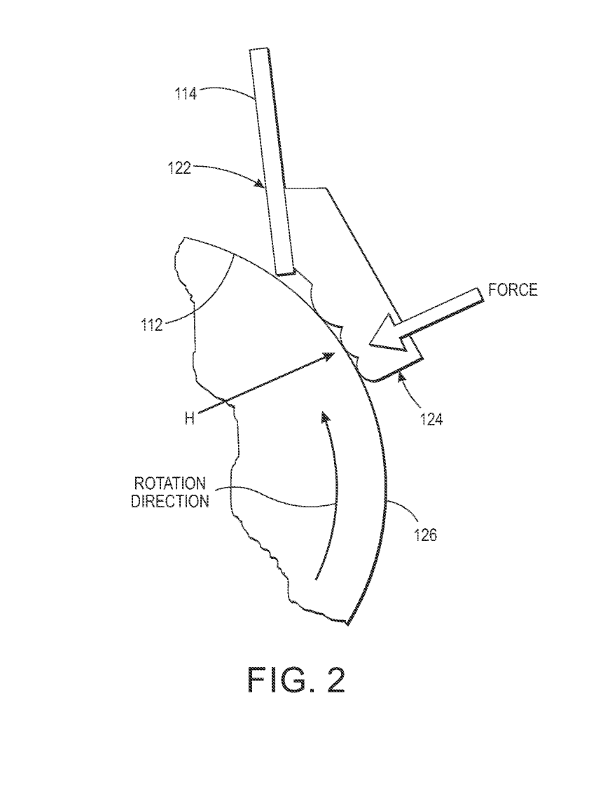

FIG. 2 is a cross-sectional view of the elements included in FIG. 1 (shown from a different angle) focused in the area around nip H. As shown in FIG. 2, the charge blade 114 has a middle region 122 and an end portion 124 where the multiple curved surfaces are located. Toner T should be able to charge and flow in this nip H to enable sufficiently charged developed mass on the photoreceptor 18 when brought into contact with the latent image. As shown in FIG. 2, the charge blade design has multiple curved surfaces, which enable more contact area in nip H between the charge blade 114 and outer surface 126 of the development roll 112, and which increases the tribo charge of the toner and provides precise metering of the amount of toner on the development roll 112. The area of the nip H impacts how well the toner charges, both average charge and charge distribution. The multiple curved surface structures can be formed by extrusion, using molds, can be formed using die presses, can be formed using milling, etc., and can be a single, monolithic piece or can be a separate component mounted to a thin blade (very similar to a conventional charge blade) which forces the multiple curved surfaces against the developer roll surface.

When some non-standard toners (e.g., toners other than those called for by the printer manufacturer) are used, they may not be able to charge fast enough with conventional flat charge blades that have a relatively smaller nip than the nip H shown in the accompanying drawings. This can lead to low density and higher background than the original toner call for by the manufacturer.

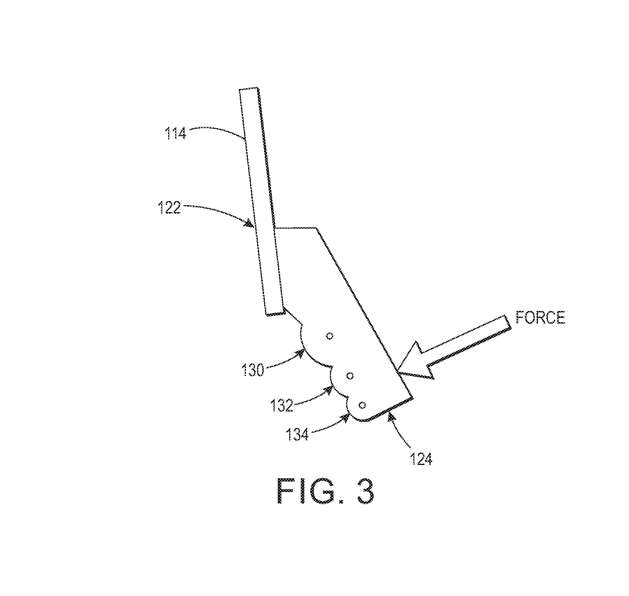

FIG. 3 is a cross-sectional view of the charge blade shown in FIGS. 1 and 2, and FIG. 4 is a perspective view of the same. As shown in FIG. 3, each curved surface 130, 132, 134 has a different radius. The first curved surface 134 provides both a nip charging contact and a metering function. The radius of the first curved surface 134 is chosen to control the amount of toner delivered to the development zone. The amount of toner is proportional to the radius of the first curved surface 134. As the radius is increased, the mass of toner allowed to remain on the developer roll is increased. The remaining curved surfaces 132, 130 have increasing radii values so that they do not further meter the toner layer, but only provide additional contact points that frictionally increase charge of the toner particles on the developer roll surface. While the exemplary design shown in the drawings has three contact points, those ordinarily skilled in the art would understand that the charge blade could include only two curves surfaces or many more than three curved surfaces, depending on the toner properties, speed of the development roll, diameter of the roll, etc. However, with structures herein, the most distal curved surface has a smaller radius than the more central curved surfaces and performs all metering, while the relatively larger radii of the more central curved surfaces increase charge and make the charge more uniform.

The structures presented herein provide improved metering and charging of a toner layer within a development cartridge. By providing multiple contact points (nips) between the charge blade and the development roll, the toner layer has more frictional area to charge, which creates a charge that is sufficiently high, and sufficiently uniform, to enable good development to the photoreceptor with no background. By providing more frictional charging area, these devices can handle a toner design that may not charge as well as the toner originally designed for a given printer. The radius of the first curved surface 134 provides both a nip forming feature, and a metering function. As the radius is reduced, the amount of toner provided to the development zone is reduced. Subsequent radii in the second and third curves surfaces 132, 130 are larger than the radius of the first curved surface 134 to ensure no toner is metered by the second and third curves surfaces 132, 130, but the second and third curves surfaces 132, 130 provide frictional charging to increase the amount and uniformity of the charge within the toner.

Stated in more generic terms, various print devices 10 (see FIG. 5, discussed below for some elements) include a media feeder 34 (one example of which is a sheet feeder); and a transfer device 18 (one example of which is a photoreceptor) adjacent the media feeder 34. The transfer device 18 receives print media 15 from the media feeder 34, and the transfer device 18 transfers marking material T (one example of which is toner) to the print media 15. A marking material feeder 112 (one example of which is a development roll) is adjacent the transfer device 18. The marking material feeder 112 supplies the marking material T to the transfer device 18. Further, a supply device 113 (one example of which is a supply roll) is adjacent the marking material feeder 112. The supply device 113 supplies the marking material T to the marking material feeder 112.

A charge blade 114 contacts the marking material feeder 112, and a charge generator 120 is electrically connected to the charge blade 114. The charge blade 114 has a middle portion 122 and an end portion 124. The middle portion 122 and the end portion 124 of the charge blade 114 can be formed of a single piece of continuous material, or can be formed separately and later attached to one another. The end portion 124 of the charge blade 114 includes curved structures 130-134 that touch the marking material feeder 112, and the end portion 124 of the charge blade 114 applies a force against the development roll 112 to enable friction between the toner T and the development roll 112, which electrically charges the toner.

Again, the end portion 124 of the charge blade 114 comprises a first curved surface 134 (e.g., a consistent/uniform arc shape) touching the marking material feeder 112, a second curved surface 132 and additional curved surfaces 130 (e.g., also a consistent/uniform arc shape, but having a radius different from the first curved surface 134) touching the marking material feeder 112. The second curved surface 132 is positioned, on the charge blade 114, between the first curved surface 134 and the middle portion 122 of the charge blade 114. Thus, the first curved surface 134 is located/positioned a longer distance from (is further away from) the middle portion 122 of the charge blade 114 relative to the second curved surface 132. Similarly, the additional curved surfaces 130 (one of which is illustrated) are positioned, on the charge blade 114, between the second curved surface 132 and the middle portion 122 of the charge blade 114. While all have uniform arc shapes in cross-section, the first curved surface 134 has a smaller radius relative to the larger radius of the second curved surface 132. Further, the additional curved surfaces 130 can have the same radius as the second curved surface 132 or can have even larger radii (however, the first curved surface 134 has the smallest radius).

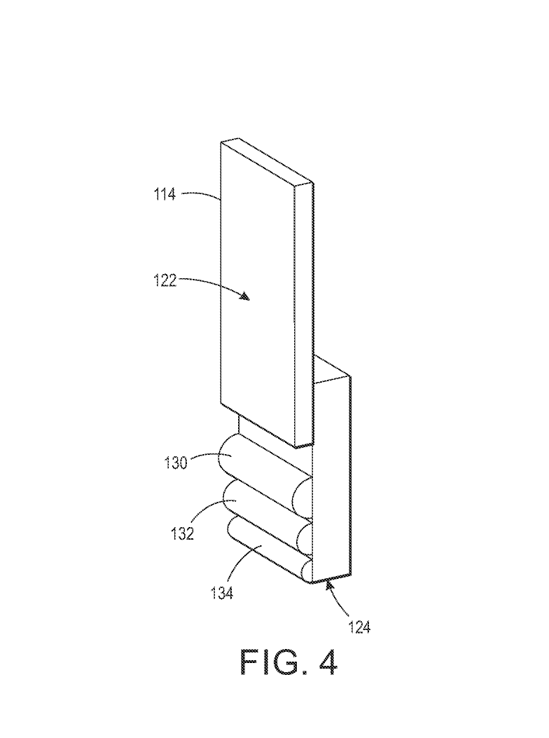

The marking material feeder 112 has an outer surface moving (e.g., rotating) in a first direction. The first curved surface 134 is positioned before the second curved surface 132 in the first direction (the second curved surface 132 is positioned between the first curved surface 134 and the middle portion 122 of the charge blade 114) such that the rotating outer surface of the marking material feeder 112 contacts the first curved surface 134 before contacting the second curved surface 132 (when moving in the first direction). Also, the first curved surface 134 has a first contact area touching the curved outer surface of the material feeder, and the second curved surface 132 similarly has a second contact area touching the curved outer surface of the material feeder. As shown most clearly in FIG. 4, the first contact area and the second contact area form parallel linear areas running in a second direction perpendicular to the first direction (running from one edge of the outer surface of the marking material feeder 112 to the opposite edge across the outer surface of the marking material feeder 112).

The first curved surface 134 and the additional curved surfaces 130 comprise contact areas touching the curved outer surface of the marking material feeder 112, thereby forming at least two nips (at least two different linear areas of contact between the charge blade 114 and the marking material feeder 112). As shown most clearly in FIG. 2, the nip contact areas of the first and second curved surface 134, 132, and the additional curved surfaces 130 are positioned in an arc matching the curvature of the outer surface of the marking material feeder 112, and all of the contact areas simultaneously touch the curved outer surface of the marking material feeder 112.

The first curved surface 134 removes marking material T and produces a first amount of charge in the marking material T on the marking material feeder 112. The second and additional curved surfaces 132, 130 do not remove any additional marking material (because they have larger radii than the first curved surface 134) but the second and additional curved surfaces 132, 130 increase the amount of, and uniformity of, charge within the marking material T on the marking material feeder 112 (to a second amount of charge that is larger and more uniform than the first amount of charge). Thus, the smaller radius of the first curved surface 134 performs all the metering of marking material T positioned on the marking material feeder 112, and the larger radius of the second curved surface 132 does not affect the amount of marking material T metered on the marking material feeder 112 by the first curved surface 134, but simply make the charge more uniform and increase the charge.

Referring to the FIG. 5 a printing machine 10 is shown that includes an automatic document feeder 20 (ADF) that can be used to scan (at a scanning station 22) original documents 11 fed from a tray 19 to a tray 23. The user may enter the desired printing and finishing instructions through the graphic user interface (GUI) or control panel 17, or use a job ticket, an electronic print job description from a remote source, etc. The control panel 17 can include one or more processors 60, power supplies, as well as storage devices 62 storing programs of instructions that are readable by the processors 60 for performing the various functions described herein. The storage devices 62 can comprise, for example, non-volatile tangible storage mediums including magnetic devices, optical devices, capacitor-based devices, etc.

An electronic or optical image or an image of an original document or set of documents to be reproduced may be projected or scanned onto a charged surface 13 or a photoreceptor belt 18 to form an electrostatic latent image. The belt photoreceptor 18 here is mounted on a set of rollers 26. At least one of the rollers is driven to move the photoreceptor in the direction indicated by arrow 21 past the various other known electrostatic processing stations including a charging station 28, imaging station 24 (for a raster scan laser system 25), developing stations 80-83, and transfer station 32. Note that devices herein can include a single development station 80, or can include multiple development stations 80-83, all of which include the charge blade 114 discussed above.

Thus, the latent image is developed with developing material to form a toner image corresponding to the latent image. More specifically, a sheet 15 is fed from a selected paper tray supply 33 to a sheet transport 34 for travel to the transfer station 32. There, the toned image is electrostatically transferred to a final print media material 15, to which it may be permanently fixed by a fusing device 16. The sheet is stripped from the photoreceptor 18 and conveyed to a fusing station 36 having fusing device 16 where the toner image is fused to the sheet. A guide can be applied to the substrate 15 to lead it away from the fuser roll. After separating from the fuser roll, the substrate 15 is then transported by a sheet output transport 37 to output trays a multi-function finishing station 50.

Printed sheets 15 from the printer 10 can be accepted at an entry port 38 and directed to multiple paths and output trays 54, 55 for printed sheets, corresponding to different desired actions, such as stapling, hole-punching and C or Z-folding. The finisher 50 can also optionally include, for example, a modular booklet maker 40 although those ordinarily skilled in the art would understand that the finisher 50 could comprise any functional unit, and that the modular booklet maker 40 is merely shown as one example. The finished booklets are collected in a stacker 70. It is to be understood that various rollers and other devices, which contact and handle sheets within finisher module 50, are driven by various motors, solenoids and other electromechanical devices (not shown), under a control system, such as including the microprocessor 60 of the control panel 17 or elsewhere, in a manner generally familiar in the art.

Thus, the multi-functional finisher 50 has a top tray 54 and a main tray 55 and a folding and booklet making section 40 that adds stapled and unstapled booklet making, and single sheet C-fold and Z-fold capabilities. The top tray 54 is used as a purge destination, as well as, a destination for the simplest of jobs that require no finishing and no collated stacking. The main tray 55 can have, for example, a pair of pass-through sheet upside down staplers 56 and is used for most jobs that require stacking or stapling

As would be understood by those ordinarily skilled in the art, the printing device 10 shown in FIG. 5 is only one example and the systems and methods herein are equally applicable to other types of printing devices that may include fewer components or more components. For example, while a limited number of printing engines and paper paths are illustrated in FIG. 5, those ordinarily skilled in the art would understand that many more paper paths and additional printing engines could be included within any printing device used with systems and methods herein.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intend portioned to be encompassed by the following claims. Unless specifically defined in a specific claim itself, steps or components of the systems and methods herein cannot be implied or imported from any above example as limitations to any particular order, number, position, size, shape, angle, color, or material.

1. A charge blade comprising:
a middle portion; and
an end portion distal to said middle portion,
said end portion touching a marking material feeder,
said charge blade metering and applying an electrical charge to marking material on said marking material feeder,
said end portion comprising:
a first curved surface touching said marking material feeder;
a second curved surface touching said marking material feeder; and
a third curved surface touching said marking material feeder,
said second curved surface being positioned, on said charge blade, between said first curved surface and said middle portion of said charge blade,
said third curved surface being positioned, on said charge blade, between said second curved surface and said middle portion of said charge blade,
said first curved surface having a smaller radius relative to a larger radius of said second curved surface, and
said second curved surface having a smaller radius relative to a larger radius of said third curved surface.

2. The charge blade according to claim 1, said marking material feeder having a surface rotating in a first direction from said end portion of said charge blade toward said middle portion of said charge blade, and
said surface of said marking material feeder contacting said first curved surface before contacting said second curved surface when rotating in said first direction.

3. The charge blade according to claim 1, said marking material feeder comprising a surface moving in a first direction,
said first curved surface comprising a first contact area touching said surface of said marking material feeder,
said second curved surface comprising a second contact area touching said surface of said marking material feeder, and
said first contact area and said second contact area comprising parallel linear areas running in a second direction perpendicular to said first direction.

4. The charge blade according to claim 1, said marking material feeder comprising a curved outer surface,
said first curved surface, said second curved surface, and said third curved surface comprising contact areas touching said curved outer surface of said marking material feeder, and
said contact areas of said first curved surface said second curved surface, and said third curved surface being positioned in an arc and all of said contact areas of said first curved surface said second curved surface, and said third curved surface simultaneously touching said curved outer surface of said marking material feeder.

5. The charge blade according to claim 1, said first curved surface producing a first amount of charge in said marking material on said marking material feeder, and said second curved surface increasing charge within said marking material on said marking material feeder to a second amount of charge that is larger than said first amount of charge.

6. The charge blade according to claim 1, said smaller radius of said first curved surface controlling an amount of marking material positioned on said marking material feeder and said larger radius of said second curved surface not affecting said amount of marking material positioned on said marking material feeder.

7. A marking material delivery apparatus comprising:
a marking material feeder, said marking material feeder supplying marking material to a transfer device;
a supply device adjacent said marking material feeder, said supply device supplying said marking material to said marking material feeder; and
a charge blade contacting said marking material feeder;
said charge blade having a middle portion and an end portion,
said end portion of said charge blade touching said marking material feeder,
said charge blade metering and applying an electrical charge to said marking material through said end portion while said marking material is on said marking material feeder,
said end portion of said charge blade comprising a first curved surface touching said marking material feeder, a second curved surface touching said marking material feeder, and a third curved surface touching said marking material feeder,
said second curved surface being positioned, on said charge blade, between said first curved surface and said middle portion of said charge blade,
said third curved surface being positioned, on said charge blade, between said second curved surface and said middle portion of said charge blade,
said first curved surface having a smaller radius relative to a larger radius of said second curved surface, and
said second curved surface having a smaller radius relative to a larger radius of said third curved surface.

8. The marking material delivery apparatus according to claim 7, said marking material feeder having a surface rotating in a first direction from said end portion of said charge blade toward said middle portion of said charge blade, and
said surface of said marking material feeder contacting said first curved surface before contacting said second curved surface when rotating in said first direction.

9. The marking material delivery apparatus according to claim 7, said marking material feeder comprising a surface moving in a first direction,
said first curved surface comprising a first contact area touching said surface of said marking material feeder,
said second curved surface comprising a second contact area touching said surface of said marking material feeder, and
said first contact area and said second contact area comprising parallel linear areas running in a second direction perpendicular to said first direction.

10. The marking material delivery apparatus according to claim 7, said marking material feeder comprising a curved outer surface,
said first curved surface, said second curved surface, and said third curved surface comprising contact areas touching said curved outer surface of said marking material feeder, and
said contact areas of said first curved surface said second curved surface, and said third curved surface being positioned in an arc and all of said contact areas of said first curved surface said second curved surface, and said third curved surface simultaneously touching said curved outer surface of said marking material feeder.

11. The marking material delivery apparatus according to claim 7, said first curved surface producing a first amount of charge in said marking material on said marking material feeder, and said second curved surface increasing charge within said marking material on said marking material feeder to a second amount of charge that is larger than said first amount of charge.

12. The marking material delivery apparatus according to claim 7, said smaller radius of said first curved surface controlling an amount of marking material positioned on said marking material feeder and said larger radius of said second curved surface not affecting said amount of marking material positioned on said marking material feeder.

13. A printing apparatus comprising:
a media feeder;
a transfer device adjacent said media feeder, said transfer device receiving print media from said media feeder, and said transfer device transferring marking material to said print media;
a marking material feeder adjacent said transfer device, said marking material feeder supplying said marking material to said transfer device;
a supply device adjacent said marking material feeder, said supply device supplying said marking material to said marking material feeder; and
a charge blade contacting said marking material feeder;
said charge blade having a middle portion and an end portion,
said end portion of said charge blade touching said marking material feeder,
said charge blade metering and applying an electrical charge to said marking material through said end portion while said marking material is on said marking material feeder,
said end portion of said charge blade comprising a first curved surface touching said marking material feeder, a second curved surface touching said marking material feeder, and a third curved surface touching said marking material feeder,
said second curved surface being positioned, on said charge blade, between said first curved surface and said middle portion of said charge blade,
said third curved surface being positioned, on said charge blade, between said second curved surface and said middle portion of said charge blade,
said first curved surface having a smaller radius relative to a larger radius of said second curved surface, and
said second curved surface having a smaller radius relative to a larger radius of said third curved surface.

14. The printing apparatus according to claim 13, said marking material feeder having a surface rotating in a first direction from said end portion of said charge blade toward said middle portion of said charge blade, and
said surface of said marking material feeder contacting said first curved surface before contacting said second curved surface when rotating in said first direction.

15. The printing apparatus according to claim 13, said marking material feeder comprising a surface moving in a first direction,
said first curved surface comprising a first contact area touching said surface of said marking material feeder,
said second curved surface comprising a second contact area touching said surface of said marking material feeder, and
said first contact area and said second contact area comprising parallel linear areas running in a second direction perpendicular to said first direction.

16. The printing apparatus according to claim 13, said marking material feeder comprising a curved outer surface,
said first curved surface, said second curved surface, and said third curved surface comprising contact areas touching said curved outer surface of said marking material feeder, and
said contact areas of said first curved surface said second curved surface, and said third curved surface being positioned in an arc and all of said contact areas of said first curved surface said second curved surface, and said third curved surface simultaneously touching said curved outer surface of said marking material feeder.

17. The printing apparatus according to claim 13, said first curved surface producing a first amount of charge in said marking material on said marking material feeder, and said second curved surface increasing charge within said marking material on said marking material feeder to a second amount of charge that is larger than said first amount of charge.

18. The printing apparatus according to claim 13, said smaller radius of said first curved surface controlling an amount of marking material positioned on said marking material feeder and said larger radius of said second curved surface not affecting said amount of marking material positioned on said marking material feeder.

19. A printing apparatus comprising:
a sheet feeder;
a photoreceptor adjacent said sheet feeder, said photoreceptor receiving print media from said sheet feeder, and said photoreceptor transferring toner to said print media;
a development roll adjacent said photoreceptor, said development roll supplying said toner to said photoreceptor;
a supply roll adjacent said development roll, said supply roll supplying said toner to said development roll; and
a charge blade contacting said development roll;
said charge blade having a middle portion and an end portion,
said end portion of said charge blade touching said development roll,
said charge blade metering and applying an electrical charge to said toner through said end portion while said toner is on said development roll,
said end portion of said charge blade comprising a first curved surface touching said development roll, a second curved surface touching said development roll, and a third curved surface touching said development roll,
said second curved surface being positioned, on said charge blade, between said first curved surface and said middle portion of said charge blade, and
said third curved surface being positioned, on said charge blade, between said second curved surface and said middle portion of said charge blade,
said first curved surface having a smaller radius relative to a larger radius of said second curved surface, and
said second curved surface having a smaller radius relative to a larger radius of said third curved surface.

20. The printing apparatus according to claim 19, said development roll having a surface rotating in a first direction from said end portion of said charge blade toward said middle portion of said charge blade, and
said surface of said development roll contacting said first curved surface before contacting said second curved surface when rotating in said first direction.

21. The printing apparatus according to claim 19, said development roll comprising a surface moving in a first direction,
said first curved surface comprising a first contact area touching said surface of said development roll,
said second curved surface comprising a second contact area touching said surface of said development roll, and
said first contact area and said second contact area comprising parallel linear areas running in a second direction perpendicular to said first direction.

22. The printing apparatus according to claim 19, said development roll comprising a curved outer surface,
said first curved surface, said second curved surface, and said third curved surface comprising contact areas touching said curved outer surface of said development roll, and
said contact areas of said first curved surface said second curved surface, and said third curved surface being positioned in an arc and all of said contact areas of said first curved surface said second curved surface, and said third curved surface simultaneously touching said curved outer surface of said development roll.

23. The printing apparatus according to claim 19, said first curved surface producing a first amount of charge in said toner on said development roll, and said second curved surface increasing charge within said toner on said development roll to a second amount of charge that is larger than said first amount of charge.

24. The printing apparatus according to claim 19, said smaller radius of said first curved surface controlling an amount of toner positioned on said development roll and said larger radius of said second curved surface not affecting said amount of toner positioned on said development roll.
